(19) United States
(12) Patent Application Publication
(10) Pub. No.: US 2024/0262471 A1
(43) Pub. Date: Aug. 8, 2024

(54) A FLOATING FABRICATION ARRANGEMENT AND A METHOD OF BUILDING FLOATING STRUCTURES

(71) Applicant: MOBIILE FABRICATION SITE AND PORT AS, Oslo (NO)

(72) Inventor: Geir GRIMSRUD, Son (NO)

(73) Assignee: Mobile Fabrication Site and Port AS, Oslo (NO)

(21) Appl. No.: 18/562,424

(22) PCT Filed: May 23, 2022
(86) PCT No.: PCT/EP2022/063882

§ 371 Date: Nov. 20, 2023

(30) Foreign Application Priority Data
May 21, 2021 (NO) 20210670

(51) Int. Cl. B63B 77/00; B63B 35/00; B63B 35/38; B63B 75/00

(52) U.S. Cl. CPC B63B 77/00; B63B 35/003; B63B 35/38; B63B 75/00

(57) ABSTRACT

A floating fabrication arrangement for building of floating structures (15). It comprises floating unit (1-4) having a continuous deck, at least one crane (5, 6) attached to said floating unit (1-4) and a mooring arrangement capable of mooring the floating unit (1-4) in a floating state on a body of water. The floating unit (1-4) having ballast chambers capable of ballasting and de-ballasting the floating unit (1-4) between a first building position where the floating unit (1-4) floats with the deck above water in a substantially horizontal position and a second inclined launch position, in which a first part of the deck is submerged and a second part of the deck is above water. A method of building floating structures is also described.

### TECHNICAL FIELD

The present invention relates to a floating fabrication arrangement for building of floating structures, such as wind turbine foundations, as well as a method of building such structures.

### BACKGROUND ART

It is convenient to build floating structures either on shore or close to a quay. If the structure is built on shore, there must be a either a crane present that can lift the structure into the water or a slip to launch the structure into the water after the structure has been built.

Alternatively, the structure can be built while it is floating. This can be done in a dry dock or on top of an already built floating sub-structure. If a dry dock is used, this has to have a sufficient size to accommodate the finished structure. For large structures there are a limited number of such docks available.

These techniques generally require a sufficient water depth next to the quay to allow for the launch of the structure without the structure hitting the seabed. The only exception is if the structure is built in a dry dock, as it is then possible to tow the dock to a place with sufficient water depth.

The above constraints put great limits on where a floating structure can be built. The limitations increase with the size and draught of the floating structure.

It is therefore often necessary to tow the floating structure from a place suitable for building the structure to the place where it is to be deployed. The distance can be considerable. This does not only take time and is costly. It is also risky, as the tow will have to be done during good weather conditions. Last, but not least, it is not very environmentally friendly to tow the structure over large distances. Especially, when building wind turbines, which are supposed to reduce the carbon emission footprint, it is desirable to make the production as environmentally friendly as possible.

The obvious solution to this would be to increase the water depth either by excavating the seabed close to an existing quay, or by building a quay, or extending an existing quay, into deeper waters. This is, however, not desirable both from an environmental perspective and due to the high costs.

Prior art references include WO 2016/138088, JP S5583678 and SE 443962. None of these meets the requirements of the present invention.

There is consequently a great need for a new solution that makes it possible to build large floating structures at an existing facility close to where the structures are to be deployed, even though the water depth close to the existing facility is too shallow for the floating structure to float.

### SUMMARY OF INVENTION

The invention solves the above problem by the arrangement defined in the subsequent claim 1 and the method of the subsequent claim 11. Convenient embodiments are defined in the depending claims.

### BRIEF DESCRIPTION OF DRAWINGS

FIG. 1 shows a set of barges with cranes being towed to the building site,

FIG. 2 shows the set of barges assembled at the building site,

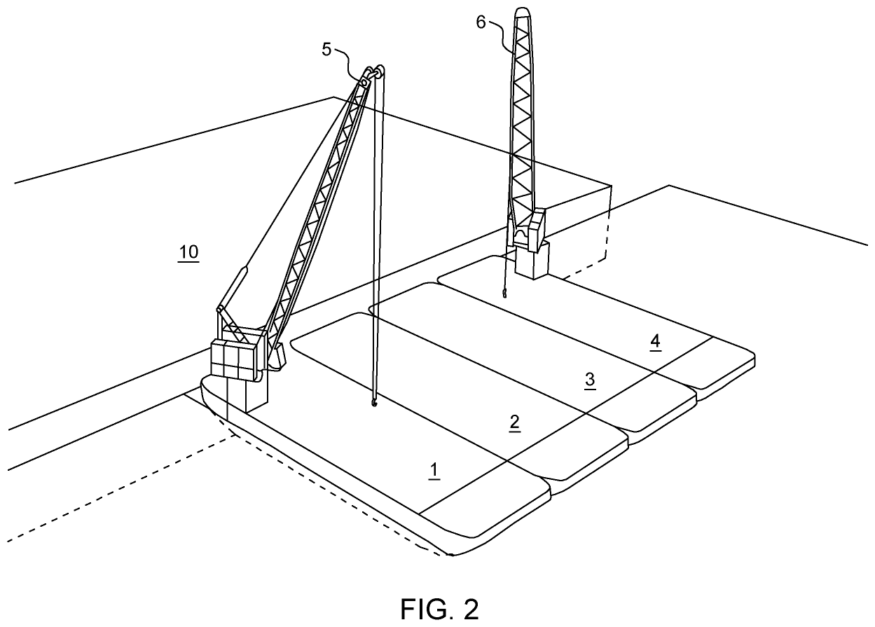

FIG. 3 shows a structure being erected on the set of barges,

FIG. 4 shows the finished structure on top of the set of barges,

FIG. 5 shows the structure about to be launched from the set of barges,

FIG. 6 shows the structure during launch,

FIG. 7 shows the structure floating outside of the set of barges, and

FIG. 8 illustrates the disassembly and towing away of the set of barges.

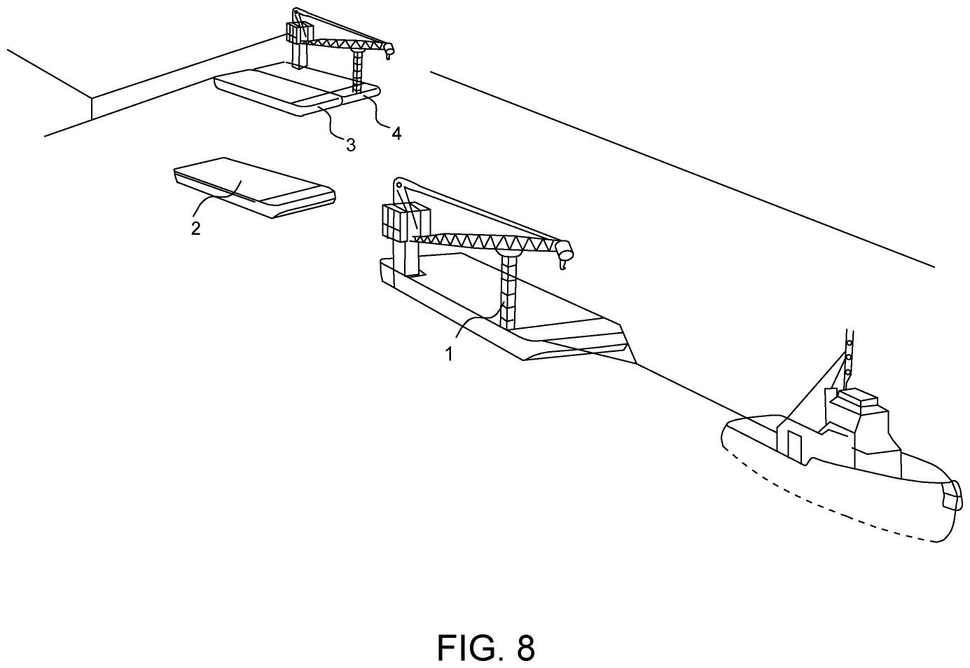

### DETAILED DESCRIPTION OF THE INVENTION

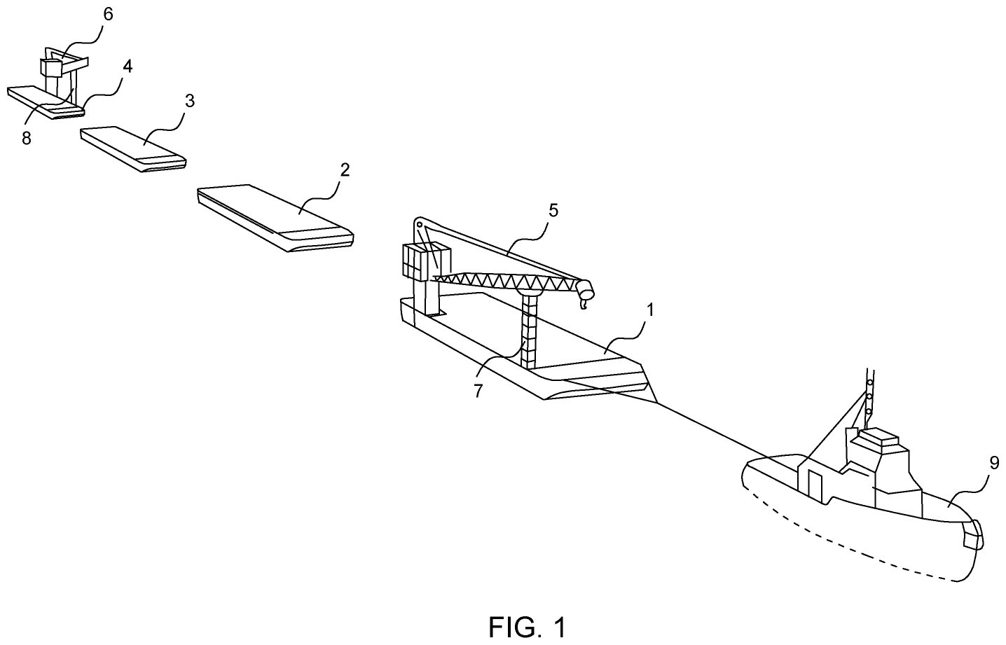

FIG. 1 shows a set of barges 1-4 being towed to the construction site. The barges may be of a standard type or standard barges that are modified to be able to connect with each other. In the drawings are shown four barges, but depending on the size of deck area and the buoyancy required, the number of barges may be smaller or greater.

Two cranes 5, 6, which are attached on top of a respective barge 1, 4 are also present. During the tow, the boom of the cranes is resting in a respective boom rest 7, 8.

The barges can conveniently be towed by a single tow vessel 9 with tow lines extending between the barges 1-4. However, it would be safer to have at least two tow vessels, one at each end of the tow.

When the barges 1-4 have reached their destination, i.e. a quay 10, the barges are lined up side-by-side and moored with one short side of the barges 1-4 next to the quay side. Preferably, the barges 1-4 abut the quay 10. Fenders may be placed between the barges and the quay. The mooring may comprise hawsers extending between the barges and the quay.

The floating unit comprising the barges 1-4 may also be moored at some distance from the quay or in a secluded area, such as within a bay or fjord.

Then the barges 1-4 are fixedly connected, such as by welding, to make up a single floating unit where the barges are unable to move or flex relative to each other. This process may also take place before the barges are moored.

Instead of welding, the barges may also be firmly connected by devices that are attached between the barges. The connection should be made in such a way that the decks of the barges 1-4 are flush and that there are no obstacles protruding above the surface of the decks.

The barges are arranged so that the two cranes 5, 6 are situated on a respective outer barge 1 and 4, and preferably close to the outer side of those barges as well as close to the inner end, i.e. the end next to the quay 10, of the barges 1, 4. For the building of smaller floating structures, one crane 5 may be sufficient.

Due to tidal differences, the deck of the barges 1-4, i.e. the floating unit will be at different altitudes relative to the quay 10. This can be at least partially compensated for by varying the ballast of the barges. Nevertheless, a ramp (not shown) may be arranged between the barges 1-4 and the quay 10. The ramp may be a small ramp solely for persons and small carry-on goods but may also be a larger ramp that can be crossed by vehicles.

The barges may also have moorings lines, such as ropes or chains, attached to their sides distal from the quay side at one end and attached to anchors at another end, such as suction anchors, placed at the seabed distant from the quay side.

With the barges 1-4 thus moored, the building of the sub-structure may commence. The elements from which the sub-structure is to be built, are brought to the quay either by lorry of by boat. The elements are conveniently hoisted onto the deck of the barges 1-4 by the cranes 5, 6.

In an alternative embodiment, the floating unit may be purpose-built as a single or multi hull structure instead of assembling it from barges.

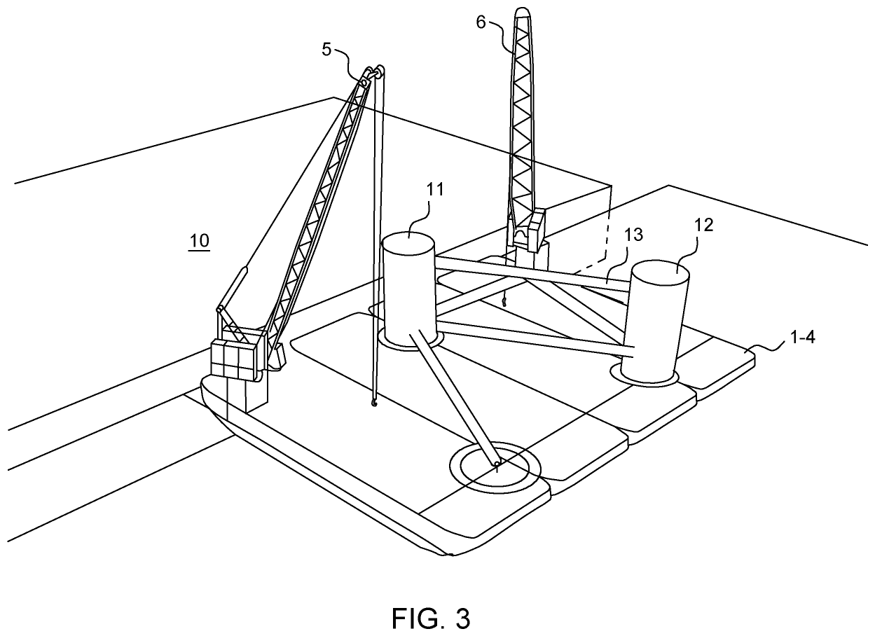

FIG. 3 shows two columns 11, 12 of the sub-structure having been installed and interconnected by struts 13. The connections are conveniently made by welding the pipes of the struts together.

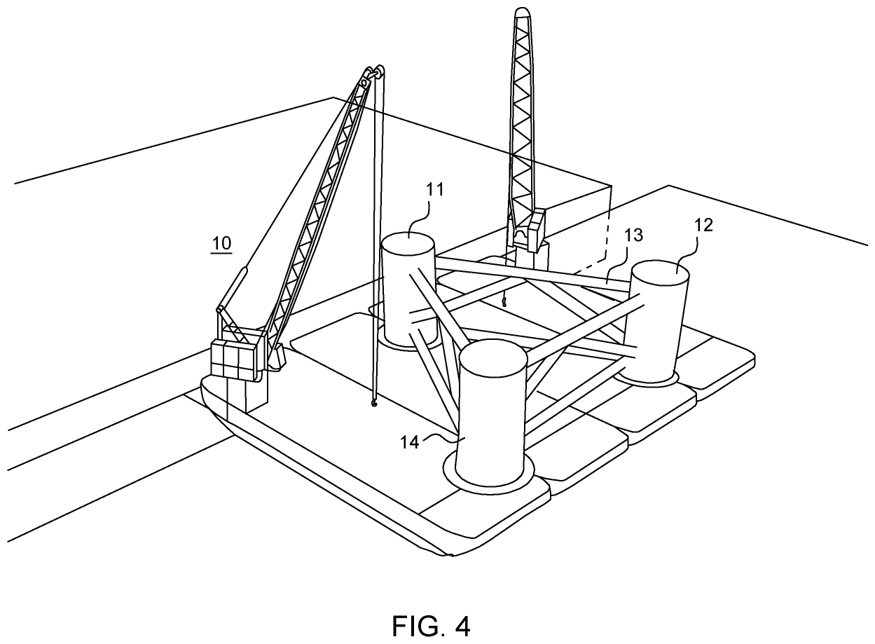

In FIG. 4 a third column 14 has been installed and connected to the two first columns 11, 12. The sub-structure 15 is now completed.

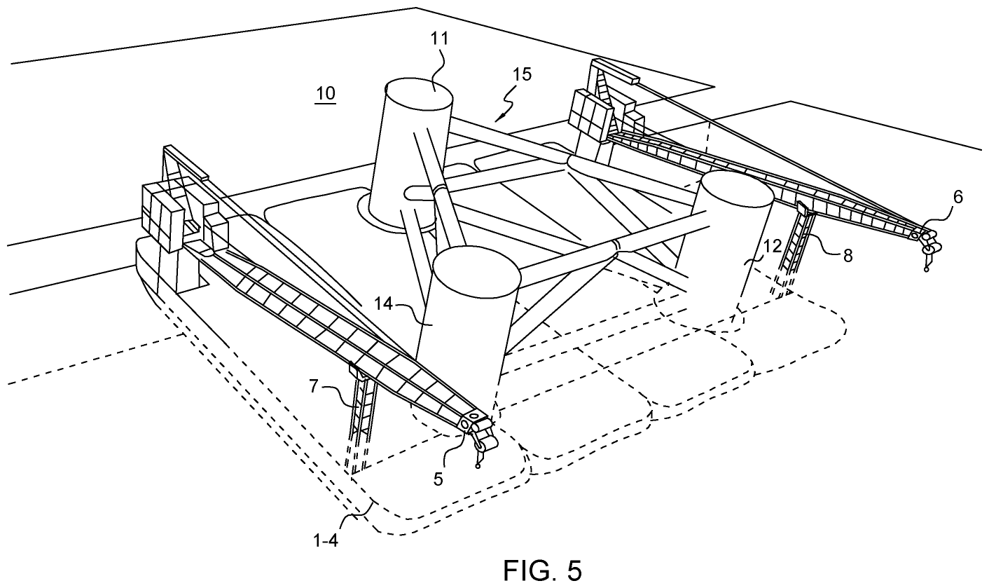

FIG. 5 shows a first step of the launching process. The booms of the cranes 5, 6 have been lowered onto the boom rests 7, 8 and secured thereto. The barges are ballasted by letting water flow into ballast chambers at the distal end of the barges 1-4. This ballasting causes the distal ends of the barges 1-4 to sink into the water. The flow of water into the ballasting chambers continues until the two columns 12, 14 closest to the outer edge of the barges 1-4 are partially submerged under water, and preferably floats off from the deck of the barges 1-4.

When the barges 1-4 have reached a sufficient inclination for the sub-structure 15 to slide off the deck and into the water, any ties between the sub-structure and the barges 1-4 are released. A winch or similar may also be activated to pull the sub-structure along the deck if it will not slide due to gravity.

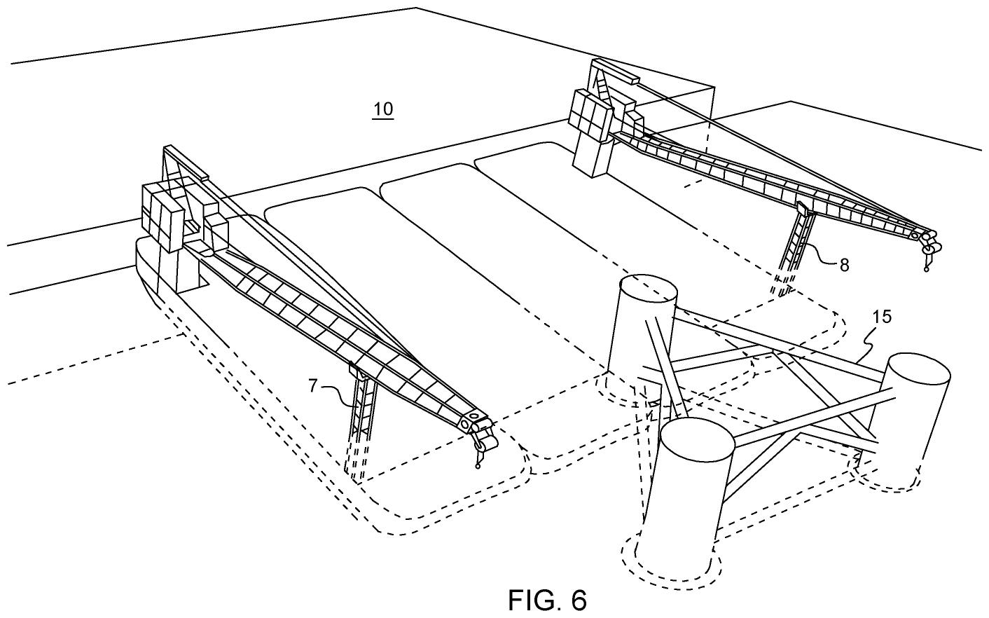

In FIG. 6 the sub-structure 15 has almost completely slid off the deck, and the innermost column 11 has started to float.

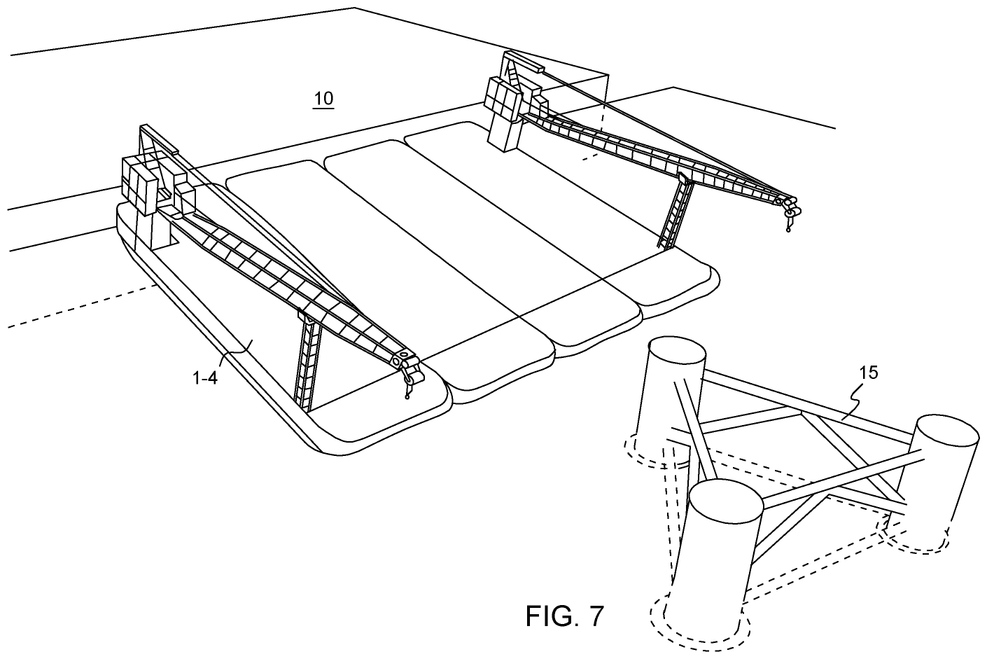

In FIG. 7 the sub-structure 15 is floating outside of the barges 1-4. At this distance from the quayside, the water depth is sufficient for the sub-structure 15 to float without touching the seabed. It can now be towed to a convenient nearby site for installation of the super-structure such as a wind turbine.

After the launch of the sub-structure 15, the barges 1-4 are de-ballasted by pumping the water in the ballasting chambers out, so that the barges 1-4 are brought up to float with the deck in a horizontal plane. Building of the next sub-structure can then be started.

When the planned number of sub-structures have been built and launched as described above, the barges 1-4 are disconnected from each other and towed away. Alternatively, the barges 1-4 may also be towed as one unit if the next use of the barges is as a single unit, such as at another location.

1-11. (canceled)

12. A floating fabrication arrangement for building of floating structures, comprising floating unit having a continuous deck, at least one crane attached to the floating unit and a mooring arrangement capable of mooring the floating unit in a floating state on a body of water, the floating unit having ballast chambers capable of ballasting and de-ballasting the floating unit between a first building position where the floating unit floats with the deck above water in a substantially horizontal position and a second inclined launch position, in which a first part of the deck is submerged and a second part of the deck is above water.

13. The arrangement of claim 1, wherein the floating unit is assembled from a plurality of barges that are firmly interconnected.

14. The arrangement of claim 1, wherein the arrangement is adapted to be moored next to a quay-side, and the first part of the deck is next to a distal side of the floating unit, i.e., facing away from the quay-side, and the second part of the deck is next to a proximal side of the floating unit, i.e. facing towards the quay-side.

15. The arrangement of claim 1, wherein the barges are interconnected with their long sides facing each other.

16. The arrangement of claim 1, wherein it comprises two cranes arranged on the deck of the outermost barges.

17. The arrangement of claim 1, wherein the barges are connected to each other by welding.

18. The arrangement of claim 1, wherein the barges are connected to each other by devices attached between the barges.

19. The arrangement of claim 3, comprising a ramp extending between the quay and the floating unit.

20. The arrangement of claim 3, wherein the mooring comprises hawsers attaching the floating unit to the quay.

21. The arrangement of claim 9, wherein the mooring comprises mooring lines attached between the floating unit and one or more anchors at the seabed.

22. A method of building floating structures, comprising the following steps:
a. mooring a floating unit having a continuous deck on a body of water;
b. bringing elements to build the floating structure to the floating structure;
c. lifting the elements onto the deck and interconnecting the elements to erect the floating structure;
d. ballasting the floating unit into an inclined position, to bring a first part of the deck below the surface of the water;
e. sliding the completed floating structure off of the floating unit and into the water; and
f. de-ballasting the floating unit to bring the deck completely out of the water.

23. The method of claim 11, comprising:
a. firmly interconnecting a plurality of barges to form a single floating unit having a continuous deck;
b. mooring the unit next to a quay; and
c. bringing elements to build the floating structure to the quay prior to lifting the elements onto the deck.
